(19) United States
(12) Patent Application Publication
(10) Pub. No.: US 2004/0090778 A1
(43) Pub. Date: May 13, 2004

(54) Fluorescent lamp frame

(75) Inventor: Shi Youl Noh, Kyonggi-do (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: FEELUX Co., Ltd.

(21) Appl. No.: 10/291,826

(22) Filed: Nov. 12, 2002

(51) Int. Cl. F21V 19/02

(52) U.S. Cl. 362/220; 362/221; 362/260

(57) ABSTRACT

Disclosed is a fluorescent lamp frame capable of varying its length. The fluorescent lamp frame includes: a first frame having an inner space, both ends perforated, and a number of fixing holes formed in at least one side and separated from one another at predetermined intervals; a second frame inserted into the inner space of the first frame in a back and forth movable manner; a frame header mounted at an end of the second frame, inserted into the inner space of the first frame together with the second frame in the back and forth movable manner, and fixed to the inside of the first frame; a power supply wire mounted between a side of the frame header and a socket located at an end of the first frame; and lamp supporters fixed on both ends of the first frame and the second frame.

### BACKGROUND OF THE INVENTION

1. Field of the Invention

The present invention relates to a fluorescent lamp, and more particularly, to a fluorescent lamp frame capable of varying its length.

2. Background of the Related Art

In general, a fluorescent lamp is installed at a dark place where people easily use it, and allows the people to discriminate things by emitting light by a power source applied to a fluorescent material. The fluorescent lamp is adhered on the ceiling of a house or an office, or on the ceiling of an electric motor or a train.

Especially, in the cost respect, the fluorescent lamp is an illumination medium having an excellent luminous effect, and so, has been widely used in the house or an industrial facility. Recently, the fluorescent lamp serves as not only light to illuminate the dark place but also a decoration to provide a visual effect by being installed in a display case or in a show room.

The fluorescent lamp includes a reflecting shade, a socket for fitting the fluorescent lamp, and a ballast for providing stabilized voltage to the fluorescent lamp.

Here, the fluorescent lamp means a lamp lit up by discharging electricity of electrodes located at both ends of a tube, in which mercury vapor of lower pressure is charged. At this time, to start the electric discharge of the fluorescent lamp, high voltage is needed. When the electric discharge is started, current is rapidly increased. Therefore, the power source is applied to the fluorescent lamp through the ballast and the socket, and then, the fluorescent lamp emits light.

Finally, a stabilized combination between the ballast and the socket of the fluorescent lamp is very important to provide the stabilized power source.

Therefore, the ballast suitable for voltage and current capacity of the fluorescent lamp must be used.

Recently, a fluorescent lamp that high voltage is applied to the fluorescent lamp through a ballast without regard to the voltage and current capacity of the fluorescent lamp can be controlled after the lighting has been disclosed.

The fluorescent lamp is operated by controlling the voltage and current through the ballast after a number of fluorescent lamps are connected in series or in parallel.

The fluorescent lamp is mounted on a fluorescent lamp frame, and the fluorescent lamp frame is fixed and installed on the ceiling.

U.S. Pat. No. 5,521,805 discloses a fluorescent lamp, which has the above structure of the fluorescent lamp frame.

As shown in FIGS. 1 to 3, the conventional florescent lamp frame includes: a pair of caps 1 having openings 2 in the outside; a first connecting terminal 3 slidably connected to one of the caps 1 and having a plug socket 3a disposed at an end; a second connecting terminal 4 slidably connected to the other cap 1 and having a plug socket 4a disposed at an end; a body 5 having both ends slidably connected to the caps 1; a circuit board 6 mounted on the upper portion of the inside of the caps 1 and the body 5 and connected and fixed to the first and second connecting terminals 3 and 4; a pair of lead wires 7 mounted inside the body 5 and an end connected and fixed to a side of the circuit board 6 and the other end connected and fixed to the other side of the circuit board 6; a fluorescent lamp 9 having both ends adhered to the caps 1 and connected with the circuit board 6 with a pair of power supply wires (not shown); and a cover 10 connected integrally to the upper portion of the outside of the caps 1 and the body 5 for protecting the circuit board 6.

On the fluorescent lamp frame, a number of fluorescent lamps, which are connected in series, can be used. At this time, as shown in FIG. 3, the plug socket 4a disposed on the second connecting terminal 4 of the first fluorescent lamp is connected to the plug socket 3a disposed on the first connecting terminal 3 of the next fluorescent lamp.

However, the fluorescent lamp frames of different sizes must be used according to the length of the fluorescent lamps. So, if short fluorescent lamps, which are mounted on the existing fluorescent lamp frame, are replaced with long fluorescent lamps to raise the indoor luminous intensity, the whole fluorescent lamp frame must be replaced.

Alternatively, to raise the indoor luminous intensity, a number of the fluorescent lamp frames can be connected in series, and the fluorescent lamps are mounted on each frame. However, because the fluorescent lamp frames are additionally connected and mounted, it is very complex and the installation cost is added.

### SUMMARY OF THE INVENTION

Accordingly, the present invention is directed to a fluorescent lamp frame that substantially obviates one or more problems due to limitations and disadvantages of the related art.

An object of the present invention is to provide a fluorescent lamp frame capable of varying its length.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the fluorescent lamp frame includes: a first frame having an inner space and a number of fixing holes formed in a side; a second frame connected to the inner space of the first frame in a back and forth movable manner; a frame header mounted at an end of the second frame, the frame header defining a variable length moving inside the first frame; a power supply wire mounted between a side of the frame header and a socket located at an end of the first frame; and lamp supporters fixed on both ends of the first frame and the second frame.

To achieve the above object, in another embodiment of the present invention, the present invention provides a fluorescent lamp frame including: a fluorescent lamp frame having a lamp supporter mounted at a side thereof; a variable part connected to the lamp frame and having a lamp supporter; and fixing parts provided on the lamp supporters and a side of the lamp frame to mount the lamp frame to an object.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a conventional fluorescent lamp frame;

FIG. 2 is a brief view showing a disassembled state of the conventional fluorescent lamp frame;

FIG. 3 is a front view showing a used state of the conventional fluorescent lamp frame;

FIG. 4 is a perspective view of a fluorescent lamp frame according to the present invention;

FIG. 5 is a perspective view showing a disassembled state of the fluorescent lamp frame according to the present invention;

FIG. 6a is a brief view of a frame header body part of the present invention;

FIG. 6b is a brief view showing a disassembled state of the frame header body part of the present invention;

FIG. 7a is a brief view of a first preferred embodiment of the frame header body part of the present invention;

FIG. 7b is a brief view showing a disassembled state of the first preferred embodiment of the frame header body part.

FIG. 8 is a brief view of a power supply wire of the present invention;

FIG. 9 is a brief view of an example of the power supply wire of the present invention;

FIG. 10 is a perspective view of another embodiment of the fluorescent lamp of the present invention;

FIG. 11 is a brief view of a fixing part of the fluorescent lamp of FIG. 10;

FIG. 12 is a brief view showing a state before the fluorescent lamp of FIG. 10 is installed on the wall surface; and

FIG. 13 is a brief view showing a state that the fluorescent lamp of FIG. 10 is installed on the wall surface.

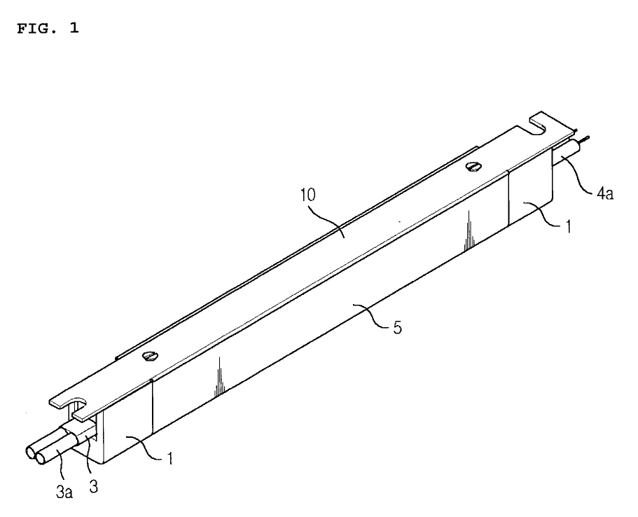

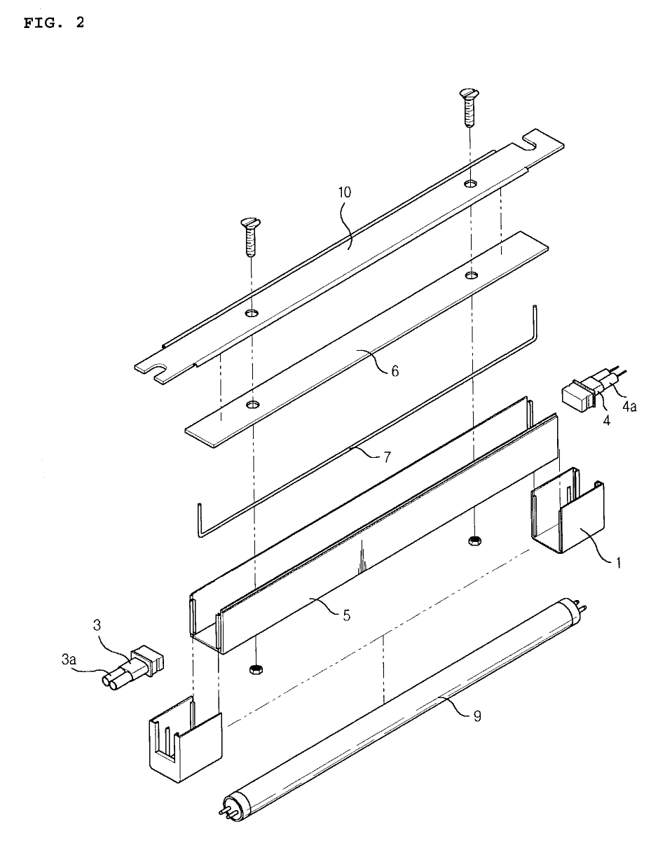

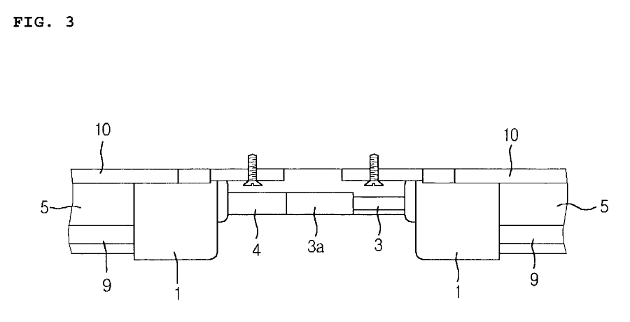

### DETAILED DESCRIPTION OF THE PREFERRED EMBODIMENT

Reference will now be made in detail to the preferred embodiments of the present invention, examples of which are illustrated in the accompanying drawings.

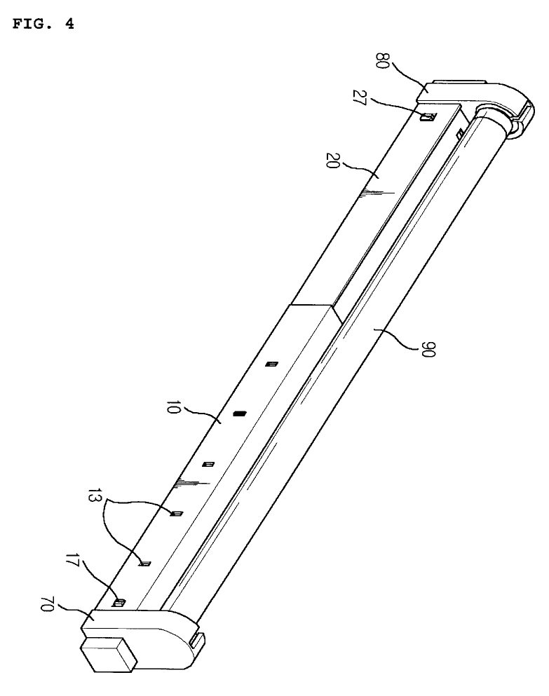

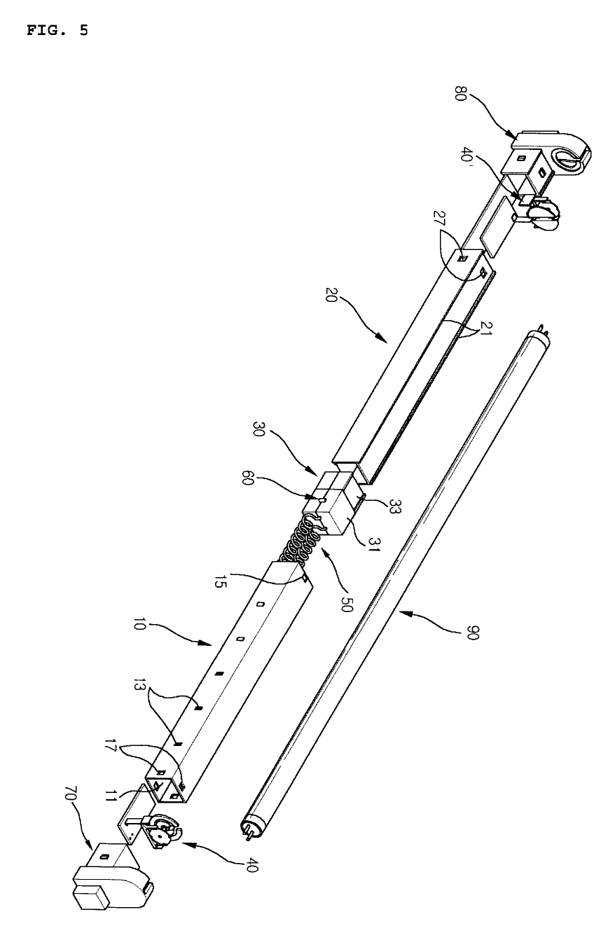

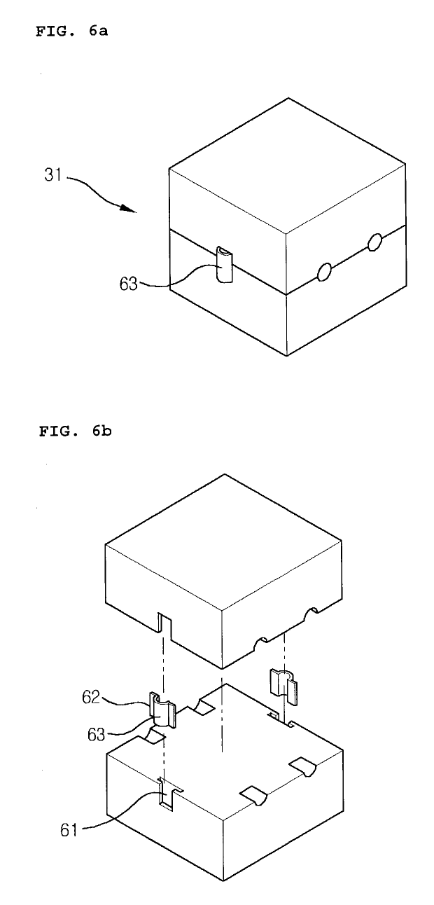

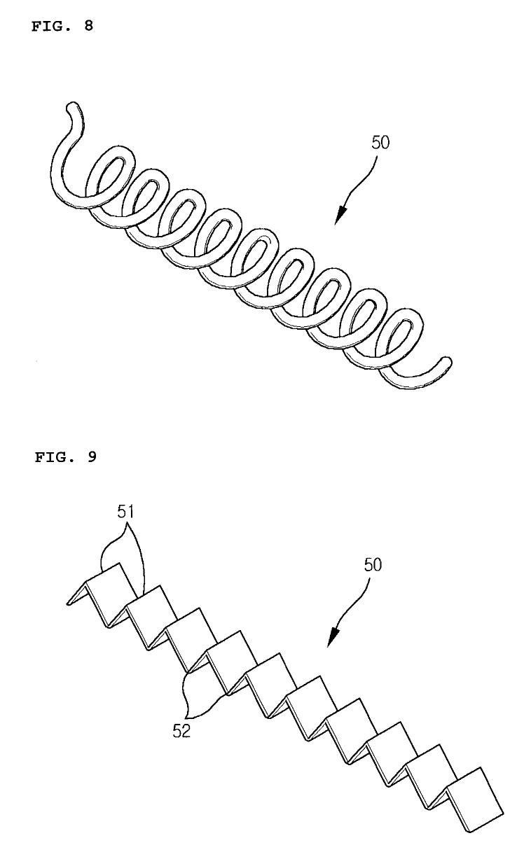

As shown in FIGS. 4 to 9, a fluorescent lamp frame according to the present invention includes a first frame 10, a second frame 20, a frame header 30, a power supply wire 50, and a pair of lamp supporters 70 and 80. The first frame 10 has both ends perforated, an inner space 11, and a number of fixing holes 13, which are formed in at least one or more sides of the outside and separated from one another at prescribed intervals. The second frame 20 is inserted into the inner space 11 of the first frame 10 and can be moved back and forth in the inner space 11. The frame header 30 is mounted at an end of the second frame 20, inserted into the inner space 11 of the first frame 10 together with the second frame 20 in the back and forth movable manner, and fixed to the inside of the first frame 10. The power supply wire 50 is mounted between a side of the frame header 30 and a socket 40 located at an end of the first frame 10. The lamp supporters 70 and 80 are fixed on the both ends of the first and second frames 10 and 20.

The first frame 10 has at least one or more protrusions 15 formed inwardly from an end thereof and coupling holes 17 formed in at least one side of the other end thereof.

Here, the lamp supporter 70 is coupled to the coupling holes 17 of the first frame, and the socket 40 is mounted at a side of the lamp supporter 70.

The second frame 20 has rails 21 formed upper and lower edges, and at least one or more coupling holes 27 formed at an end thereof.

The lamp supporter 80 is coupled to the coupling holes 27 of the second frame 20, and a socket 40′ is mounted at a side of the lamp supporter 80.

The frame header 30 includes: a frame header body part 31 formed smaller than the inner space 11 of the first frame 10 and inserted into the inner space 11 in a movable manner, a frame header connecting part 33 connected with the frame header body part 31 and inserted into the inside of the second frame 20, and fixing parts 60 mounted on both sides of the frame header body part 31.

Each of the fixing parts 60 includes guide spaces 61 formed in the inside of both sides of the frame header 30, elastic plates 62 movably mounted in the guide spaces 61, and a protrusion 63 formed on the center of each elastic plate 62.

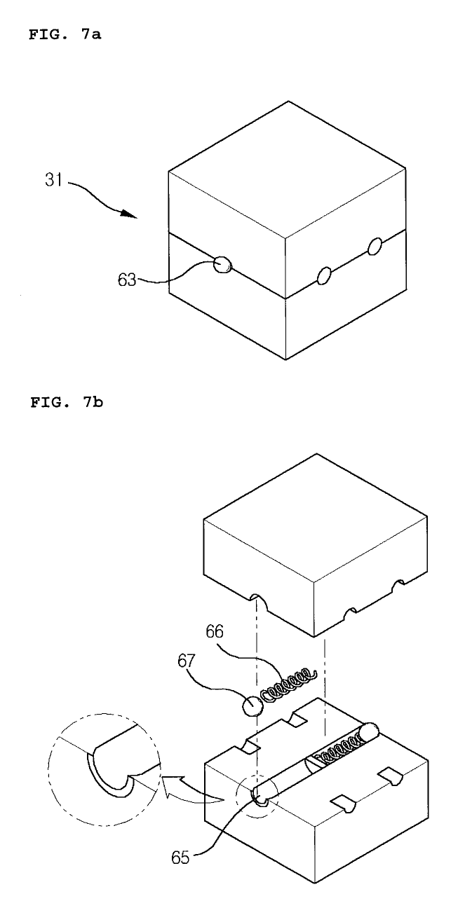

FIGS. 7a and 7b show different embodiments of the fixing part 60 according to the present invention. The fixing part has a spring 66 mounted in a cylindrical hole 65 formed in a side of the frame header 30, and a ball 67 located at the upper end of the spring 66 and partially exposed to the outside of the hole 65.

To prevent separation of the ball 67 from the hole 65, a side of the hole 65 is formed smaller than the diameter of the ball 67.

Meanwhile, the power supply wire is in the form of a spiral.

FIG. 9 shows another embodiment of the power supply wire 50 according to the present invention. The power supply wire 50 is formed in a film type, and has a wave form section, in which top portions 51 and bottom portions 52 are formed alternately.

The unexplained reference numeral 90 indicates a fluorescent lamp mounted between the sockets 40 and 40′ after the fluorescent lamp frame is assembled.

An assembling process of the fluorescent lamp frame according to the present invention will now be described.

First, the power supply wire 50 is connected and mounted between the side of the frame header 30 and the socket 40 located at one end of the first frame 10.

After that, the lamp supporter 70, on which the socket 40 is mounted, is mounted at one end of the first frame 10.

Next, the frame header connecting part 33 of the frame header 30 is inserted and mounted at one end of the second frame 20, and then, the second frame 20 and the frame header 30 are connected integrally.

After that, a wire part (not shown) is connected and mounted between a side of the frame header 30 and the socket 40′ located at one end of the second frame 20.

The lamp supporter 80, on which the socket 40′ is mounted, is assembled and mounted on the side of the second frame 20.

Next, the second frame 20 is inserted into the inner space 11 of the first frame 10 together with the frame header 30, which is mounted at the end of the second frame 20 in the back and forth movable manner, and fixed to the inside of the first frame.

The frame header body part 31 of the frame header 30 has the fixing parts 60 at both sides to be fixed to the inner space of the first frame 10.

Here, the protrusion 63 of each fixing part 60 is protruded from the center of the elastic plate 62, and the elastic plate 62 is movably mounted inside the guide space 61 of the frame header body part 31.

As the result, the protrusion 63 of the elastic plate 62 is caught and fixed to the fixing hole 13 of the first frame 10 by elasticity and movement.

Meanwhile, at least one or more protrusions 15 are formed inwardly from one side of the first frame 10 to prevent separation of the second frame 20, which is movably mounted inside the first frame 10, from the first frame 10.

Here, the length of each protrusion 15 is equal to the height of the rail 21 of the second frame 20, and the protrusions 15 are caught to the frame header body part 31 of the frame header 30.

Therefore, the frame header body part 31 of the frame header 30 is locked by the protrusions 15 of the first frame 10, and thereby, the second frame 20 connected integrally with the frame header 30 is mounted inside the first frame in the back and forth movable manner without separation.

Finally, after the second frame 20 is inserted into the first frame 10, the first and second frames 10 and 20 are fixed and mounted by the fixing parts 60 of the frame header 30.

The fluorescent lamp 90 is fit and mounted between the sockets 40 and 40′ mounted at both ends of the fluorescent lamp frame.

Here, the fluorescent lamp frame can be varied in length by the first frame 10 and the second frame 20, which is inserted into the first frame in the back and forth movable manner.

According to the recent technique, the fluorescent lamp 90 is operated by controlling voltage and current with one ballast (not shown) without regard to voltage and current capacity of the fluorescent lamp 90.

Therefore, the fluorescent lamp frame can be varied in length according to the size of the fluorescent lamp 90, and the fluorescent lamps 90 of various sizes can be replaced.

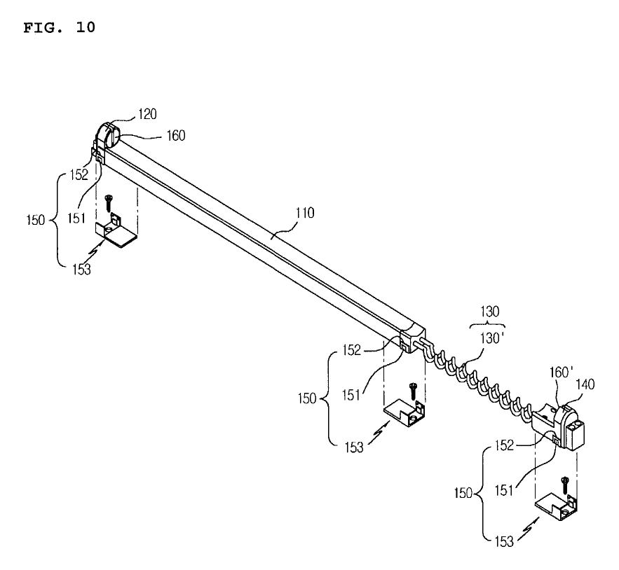

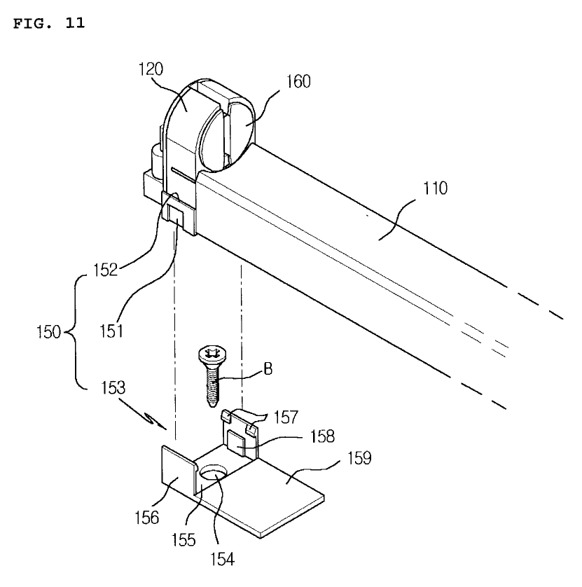

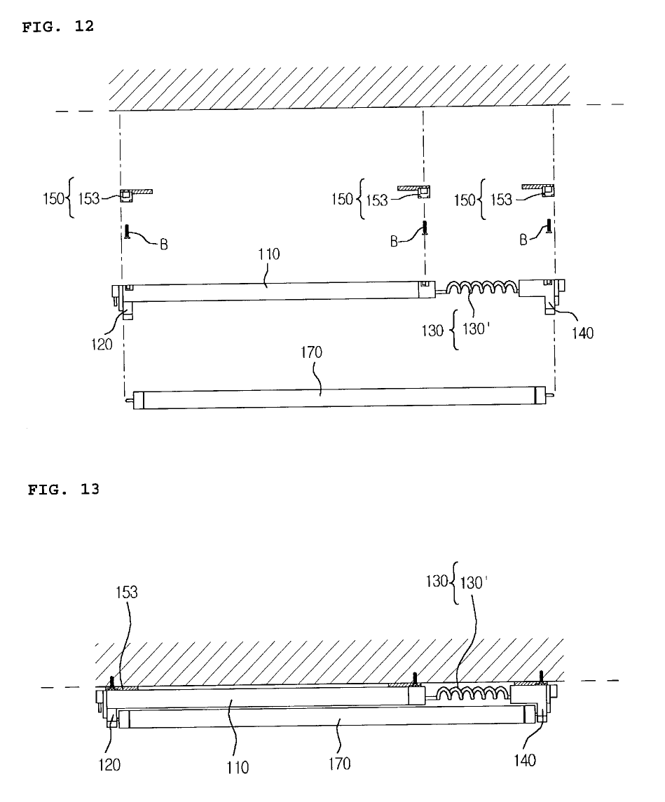

In another embodiment of the present invention, as shown in FIGS. 10 to 13, the fluorescent lamp includes: a fluorescent lamp frame 110 having a lamp supporter 120 mounted at a side thereof; a variable part 130 connected to the lamp frame 110 and having a lamp supporter 140; and fixing parts 150 provided on the lamp supporters 120 and 140 and a side of the lamp frame 110 to mount the lamp frame 110 to an object.

The variable part 130 is a coil wire 130′ having a power source wire inside, so that the variable part 130 can contract and expand easily and make electric current through the wire inside.

The fixing part 150 includes separation preventing holes 151 formed in both sides of the lower end of the lamp supporters 120 and 140, locking jaws 152 formed on the upper portions of the separation preventing holes 151, and fixing brackets 153 detachably mounted on the separation preventing holes 151 and the locking jaws 152.

The fixing part 150, which is mounted on the side end of the lamp frame 110, includes separation preventing holes 151 formed in both sides of the lower end of the lamp frame 110, locking jaws 152 formed on the upper portions of the separation preventing holes 151, and fixing brackets 153 detachably mounted on the separation preventing holes 151 and the locking jaws 152.

Here, the fixing bracket 153 includes: a base part 155 having a coupling hole 154 formed at a side thereof to mount a coupling member B later; side wall parts 156 extending upwardly from both ends of the base part 155; locking protrusions 157 for fastening end portions of the side wall parts 156 to the locking jaws 152; separation preventing protrusions 158 separated from the locking protrusions 157 at a predetermined interval, each of the locking protrusions 157 being formed on a side of each side wall part 156 to be mounted to the separation preventing hole 151; and a fixing bracket supporter 159 extending to a side of the base part 155.

The lamp supporter 120 has a socket 160 mounted at a side thereof, and the lamp supporter 140 has a socket 160′ mounted at a side thereof.

The unexplained reference numeral 170 designates a fluorescent lamp, which will be mounted between the sockets 160 and 160′ after the lamp frame is assembled.

An assembling process of the fluorescent lamp frame according to the present invention will now be described as follows.

First, an electric wire (not shown) is connected between the socket 160 located on the lamp supporter 120 and an end of the side of the lamp frame 110 opposed to the lamp supporter 120, and then, located inside the lamp frame 110.

After that, the lamp supporter 120, on which the socket 160 is mounted, is mounted on the side end of the lamp frame 110.

Next, the coil wire 130′, which is the variable part 130, is connected to the side end of the lamp frame 110.

A process for installing the assembled fluorescent lamp frame to the object will be described as follows.

First, the coupling member B is inserted into the coupling hole 154, and the fixing brackets 153 are fixed to the object (the wall surface or the ceiling), on which the lamp frame will be mounted later.

Next, the locking protrusions 157 and the separation preventing protrusions 158 of the fixing bracket 153 engage the locking jaws 152 and the separation preventing holes 153 formed on the lamp supporter 120 and the side of the lamp frame 110, so that the lamp frame 110 is fixed to the fixing brackets 153.

Furthermore, the locking jaws 152 and the separation preventing holes 153 of the lamp supporter 140 engage the locking protrusions 157 and the separation preventing protrusions 158 of the fixing bracket 153, so that the lamp supporter 140 is fixed to the fixing brackets 153.

Next, the fluorescent lamp 170 is mounted between the socket 160 of the lamp supporter 120 and the socket 160′ of the lamp supporter 140.

Moreover, according to the recent technique, the fluorescent lamp 170 is operated by controlling voltage and current with one ballast (not shown) without regard to voltage and current capacity of the fluorescent lamp 170.

Therefore, the fluorescent lamp frame can be varied in length according to the size of the fluorescent lamp 170, and the fluorescent lamps 170 of various sizes can be replaced.

As described above, the fluorescent lamps 90 of various sizes can be mounted and replaced on one fluorescent lamp frame because the fluorescent lamp frame can be varied in length.

That is, according to the indoor luminous intensity, the fluorescent lamps of various sizes, which are mounted on the fluorescent lamp frame, can be easily replaced.

As the result, when the fluorescent lamps of different sizes on the fluorescent lamp frame are replaced, the replacement cost is reduced and the fluorescent lamps are easily replaced.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A fluorescent lamp frame comprising:
a first frame having an inner space and a number of fixing holes formed in a side;
a second frame connected to the inner space of the first frame in a back and forth movable manner;
a frame header mounted at an end of the second frame, the frame header defining a variable length moving inside the first frame;
a power supply wire mounted between a side of the frame header and a socket located at an end of the first frame; and
lamp supporters fixed on both ends of the first frame and the second frame.

2. The fluorescent lamp frame according to claim 1, wherein the second frame has rails formed on both edges of at least one or more sides.

3. The fluorescent lamp frame according to claim 1, wherein the frame header has fixing parts mounted on at least one or more sides.

4. The fluorescent lamp frame according to claim 3, wherein the fixing part includes guide spaces formed in at least one or more sides of the frame header, elastic plates movably mounted in the guide spaces, and protrusions formed on the center of the elastic plates.

5. The fluorescent lamp frame according to claim 3, wherein the fixing part has a spring mounted in the inside of a cylindrical hole formed in at least one or more sides of the frame header, and a ball located on the upper end of the spring and partially exposed to the outside of the hole.

6. The fluorescent lamp frame according to claim 1, wherein the at least one or more protrusions are formed inwardly from an end of the first frame to prevent separation of the second frame, which is movably mounted inside the first frame, from the first frame, the protrusions being caught to the frame header body part of the frame header.

7. The fluorescent lamp frame according to claim 1, wherein the power supply wire is in the form of a spiral.

8. The fluorescent lamp frame according to claim 1, wherein the power supply wire is in a film type, and has top portions and bottom portions formed alternately.

9. A fluorescent lamp frame comprising:
a fluorescent lamp frame having a lamp supporter mounted at a side thereof;
a variable part connected to the lamp frame and having a lamp supporter; and
fixing parts provided on the lamp supporters and a side of the lamp frame to mount the lamp frame to an object.

10. The fluorescent lamp frame according to claim 9, wherein the variable part is a coil wire 130′ having a power source wire inside

11. The fluorescent lamp frame according to claim 9, wherein the fixing part includes separation preventing holes formed in both sides of the lower end of the lamp supporters, locking jaws formed on the upper portions of the separation preventing holes, and fixing brackets detachably mounted on the separation preventing holes and the locking jaws.

12. The fluorescent lamp frame according to claim 11, wherein the fixing bracket includes a base part having a coupling hole, side walls extending upwardly from both sides of the base part, locking protrusions formed on ends of the side walls and fixed to the locking jaws, and separation preventing protrusions formed on the side walls and fixed to the separation preventing holes.
